(19) United States
(12) Patent Application Publication
(10) Pub. No.: US 2007/0154633 A1
(43) Pub. Date: Jul. 5, 2007

(54) Method and device for coating plastic optical fiber with resin

(76) Inventors: Rei Miyasaka, Shizuoka (JP); Tadahiro Kegasawa, Shizuoka (JP); Akihiko Takeda, Shizuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 11/547,960

(22) PCT Filed: Mar. 29, 2005
(86) PCT No.: PCT/JP05/06571

§ 371 Date: Oct. 10, 2006

(30) Foreign Application Priority Data
Apr. 8, 2004 (JP) 2004-114507

(51) Int. Cl. B05D 5/06

(52) U.S. Cl. 427/163.2

(57) ABSTRACT

A coating apparatus having a die (30) and a nipple (31) coats a plastic optical fiber (11) with a protective layer (39) formed from a thermoplastic resin (32). The diameter T_{A} (μm) of the die, the outer diameter T_{B1} (μm) of the nipple, the inner diameter T_{B2} (μm) of the nipple and the diameter D (μm) of the optical plastic fiber satisfy the following formulae:
20 (μm)≦(T_{A}−T_{B1})≦1500 (μm)
20 (μm)≦(T_{B2}−D)≦600 (μm)
400 (μm)<(T_{B1}−T_{B2})≦1500 (μm)

Thereby, the thermoplastic resin (32) is coated on the plastic optical fiber (11) without causing stress distribution to the plastic optical fiber (11).

### TECHNICAL FIELD

The present invention relates to a method and an apparatus for coating a plastic optical fiber with resin.

### BACKGROUND ART

Because of the larger transmission loss than a glass optical fiber, the plastic optical fiber is not suitable in transmitting optical signals for a long distance. Despite larger transmission loss than glass optical fiber, the plastic optical fiber has various merits, such as facility in connection due to a large diameter, facility in fiber terminal process, non-necessity for core alignment with high precision, cost reduction of the connecters, low danger to prick into human body, easy construction, high resistance to vibration and low price. Accordingly, it is planned to utilize the plastic optical fiber not only as household and automobile purposes but as a short-distance, high-capacity cable such as inner wirings for high-speed data processing device and a digital video interface (DVI) link.

The plastic optical fiber is composed of a core part whose main component is organic compounds of polymer matrix, and a clad part composed of organic materials having different refractivity from the core part. The plastic optical fiber is produced by forming a fiber including the core part and the clad part at the same time by drawing or extruding a pre-polymer. It is also possible to produce the plastic optical fiber by forming an optical fiber base material (hereinafter referred to “preform”), and melt-drawing the preform.

In producing the plastic optical fiber (hereinafter referred to as “POF”) from the preform, the POF with a desirable diameter is formed by melt-drawing the preform at a temperature from 180° C. to 260° C. During the melt-drawing process, the lower end of the preform is drawn to extend the preform while the preform is heated in a cylindrical heating furnace with an electric heater. For instance, after holding the preform, the preform is slowly moved down into the heating furnace to melt the preform in the heating furnace. When the preform is softened enough that the molten part of the preform is partially moved down due to its gravity, the leading end of the molten preform is drawn and hooked to a drawing roller, so that the preform is continuously extended to form the POF (see Japanese Laid-Open Patent Publication (JP-A) No. 11-337781, for example).

In order to apply the POF produced in this way to various purposes, the outer surface of the POF is coated for protection (forming a protective layer, for instance), or the POF is held in a tube with an inner diameter enough for inserting the POF, although the bare POF is used for some limited purposes. By protecting the POF, it is possible to prevent flaw, damage, structural irregularity such as micro-bending, decrease in optical properties, and so forth, in handling the optical fiber or in using the optical fiber in a bad environment. Examples of the materials to protect the POF are thermoplastic resin, such as polyvinyl chloride, Nylon™, polypropylene, polyester, polyethylene, ethylene vinyl acetate copolymer, ethylene ethylacrylate copolymer (EEA). It is also possible to apply other thermoplastic resin than those listed above. Conventionally, as described in Japanese Laid-Open Patent Publication (JP-A) No. 11-337781, the protective layer is formed on the POF by passing the POF through a chamber containing molten polymer or polymerizable composition, and by solidifying the polymer or polymerizable composition on the POF after passing the chamber.

A coating device having a die and a nipple can decrease variation in the outer diameter of the POF, and can prevent breakage of the POF even if the coating layer is continuously formed for a long period (see JP-A No. 4-254441, for example). The coating device described in JP-A No. 10-194793 makes it possible to prevent overflow of the thermoplastic resin out of the nipple during the coating process, and thus possible to form the protective layer with uniform thickness. Moreover, as described in JP-A No. 2002-18926, it is possible to prevent thickness deviation in the protective layer around the POF.

However, since the POF itself is plastic (for example, polyemthyl methacrylate; PMMA), the properties of the POF (for example transmission loss) tend to become worse because of the thermal energy to melt the protective layer resin (thermoplastic resin is normally used) at a temperature of 150° C. or higher. In the coating method described in JP-A No. 4-254441, it is possible to decrease the fluctuation of the diameter of the protective layer and thus to obtain a plastic optical fiber strand (optical fiber strand) with excellent appearance by solving the problem of overflowing the thermoplastic resin out of the nipple. This coating method, however, does not deal with the problem of deterioration in the transmission loss caused by thermal damage to the POF during the coating process. In addition, the coating method and device described in JP-A Nos. 10-94793 and 2002-18926 do not address the problem of thermal damage to the POF, although the technique in these references can improve accuracy and stability in size of the coating layer.

In coating the protective layer on the POF, stress is distributed in the layer and thus the refractive index in the manufactured POF is deviated. As a result, the transmission loss will increase because the transmission light through the POF is scattered. Moreover, when external air is introduced in forming the protective layer on the POF, the interface between the POF and the protective layer becomes uneven, and thus the transmission loss will increase.

An object of the present invention is to provide a method and a device for coating a plastic optical fiber that is capable of rapid and stable coating without causing thermal damage and mechanical damage due to stress distribution.

### DISCLOSURE OF INVENTION

In order to achieve the above objects, the inventors have found out that it is possible to coat a plastic optical fiber with a protective layer and to prevent increase in the transmission loss by optimizing the relationship between the diameter of the plastic optical fiber and the shape of a mold having a die and a nipple as a passage of a thermoplastic resin for the protective layer.

In coating the plastic optical fiber with the protective layer, the diameter T_{A} (μm) of the die, the outer diameter T_{B1} (μm) of the nipple, the inner diameter T_{B2} (μm) of the nipple and the diameter D (μm) of the optical plastic fiber satisfy the following formulae:
20 (μm)≦(T_{A}−T_{B1})≦1500 (μm) (1)
20 (μm)≦(T_{B2}−D)≦600 (μm) (2)
400 (μm)<(T_{B1}−T_{B2})≦1500 (μm) (3)

When the diameter D of the plastic optical fiber is 200 μm to 1500 μm, the thickness T_{c} of the protective layer of thermoplastic resin is preferably 100 μm to 500 μm. The diameter D of the plastic optical fiber is preferably 200 μm to 800 μm.

The value (T_{A}−T_{B1}) in the above formula (1) is preferably 200 μm to 1200 μm, and more preferably 400 μm to 1000 μm. The value (T_{B2}−D) in the above formula (2) is preferably 50 μm to 400 μm, and more preferably 70 μm to 150 μm. The value (T_{B1}−T_{B2}) in the above formula (3) is preferably equal to or less than 1000 μm, and more preferably equal to or less than 500 μm. In some of the coating apparatuses such as the tubing type and the pressure type, the position of the die and the nipple are different with respect to the direction to feed the plastic optical fiber, so the diameter T_{A} (μm) of the die, the outer diameter T_{B1} (μm) and the inner diameter T_{B2} (μm) are not always in the same plane perpendicular to the feeding direction of the plastic optical fiber.

The melt flow rate of the thermoplastic resin at the melting temperature of 190° C. is preferably 5 g/10 min to 150 g/10 min.

According to the present invention, since the diameter T_{A} (μm) of the die, the outer diameter T_{B1} (μm) of the nipple, the inner diameter T_{B2} (μm) of the nipple and the diameter D (μm) of the optical plastic fiber are optimized as described above, the stress to the optical fiber in the coating process decreases, and thus it is possible to prevent increase in the transmission loss. Moreover, the coating layer can be formed stably without increasing the transmission loss of the plastic optical fiber, so the productivity of the plastic optical fiber increases. Furthermore, since the plastic optical fiber is shielded from external air during the coating process, it is possible to prevent increase in the transmission loss caused by unevenness of the interface between the plastic optical fiber and the thermoplastic resin as the coating layer. Moreover, the appearance of the plastic optical fiber improves.

### BRIEF DESCRIPTION OF DRAWINGS

FIG. 1 is a schematic view of a coating line according to the present invention; and

FIG. 2 is a sectional view, in essential part, of a coating apparatus according to the present invention.

### BEST MODE FOR CARRYING OUT THE INVENTION

Initially, the raw polymer, the polymerization initiator, the chain transfer agent, the refractive index control agent (dopant) preferably used in this embodiment are explained. Then, as an example of the plastic optical fiber (POF), the method to manufacture the preform and the POF of the graded index (GI) type POF are explained. The GI type POF with high transmittance has a refractive index profile in which the refractive index gradually changes from the center to the surface of the core part. Thereafter, the method and apparatus for coating the POF are explained. It is to be noted that the embodiments described below do not limit the scope of the present invention.

As the raw material of the core part, it is preferable to select a polymerizable monomer that is easily bulk polymerized. Examples of the raw materials with high optical transmittance and easy bulk polymerization are (meth)acrylic acid esters [(a) (meth)acrylic ester without fluorine, (b) (meta)acrylic ester containing fluorine], (c) styrene type compounds, (d) vinyl esters, polycarbonates, or the like. The core part may be formed from homopolymer composed of one of these monomers, from copolymer composed of at least two kinds of these monomers, or from a mixture of the homopolymer(s) and/or the copolymer(s). Among them, (meth)acrylic acid ester can be used as a polymerizable monomer.

Concretely, examples of the (a) (meth)acrylic ester without fluorine as the polymerizable monomer are methyl methacrylate (MMA); ethyl methacrylate; isopropyl methacrylate; tert-butyl methacrylate; benzyl methacrylate (BzMA); phenyl methacrylate; cyclohexyl methacrylate, diphenylmethyl methacrylate; tricyclo [5.2.1.0^{2.6}] decanyl methacrylate; adamanthyl methacrylate; isobonyl methacrylate; methyl acrylate; ethyl acrylate; tert-butyl acrylate; phenyl acrylate, and the like. Examples of (b) (meth)acrylic ester with fluorine are 2,2,2-trifluoroethyl methacrylate; 2,2,3,3-tetrafluoro propyl methacrylate; 2,2,3,3,3-pentafluoro propyl methacrylate; 1-trifluoromethyl-2,2,2-trifluoromethyl methacrylate; 2,2,3,3,4,4,5,5-octafluoropenthyl methacrylate; 2,2,3,3,4,4,-hexafluorobutyl methacrylate, and the like. Further, in (c) styrene type compounds, there are styrene; α-methylstyrene; chlorostyrene; bromostyrene and the like. In (d) vinylesters, there are vinylacetate; vinylbenzoate; vinylphenylacetate; vinylchloroacetate; and the like. The polymerzable monomers are not limited to the monomers listed above. Preferably, the kinds and composition of the monomers are selected such that the refractive index of the homopolymer or the copolymer in the core part is similar or higher than the refractive index in the clad part. As the polymer for the raw material, polymethyl methacrylate (PMMA), which is a transparent resin, is more preferable.

When the POF is used for near infrared ray, the C—H bond in the optical member causes absorption loss. By use of the polymer in which the hydrogen atom (H) of the C—H bond is substituted by the heavy hydrogen (D) or fluorine (F), the wavelength range to cause transmission loss shifts to larger wavelength region. U.S. Pat. No. 5,541,247 (counterpart of Japanese Patent No. 3332922) teaches the examples of such polymers, such as deuteriated polymethylmethacrylate (PMMA-d8), polytrifluoroethylmethacrylate (P3FMA), polyhexafluoro isopropyl-2-fluoroacrylate (HFIP2-FA), and the like. Thereby, it is possible to reduce the loss of transmission light. It is to be noted that the impurities and foreign materials in the monomer that causes dispersion should be sufficiently removed before polymerization so as to keep the transparency of the POF after polymerization.

In polymerizing the monomer to form the polymer as the core part and the clad part, polymerization initiators can be added to initiate polymerization of the monomer. The polymerization initiator to be added is appropriately chosen in accordance with the monomer and the method of polymerization. Examples of the polymerization initiators that generate radicals are peroxide compounds, such as benzoil peroxide (BPO); tert-butylperoxy-2-ethylhexanate (PBO); di-tert-butylperoxide (PBD); tert-butylperoxyisopropylcarbonate (PBI); n-butyl-4,4-bis(tert-butylperoxy)valarate (PHV), and the like. Other examples of the polymerization initiators are azo compounds, such as 2,2′-azobisisobutylonitril; 2,2′-azobis(2-methylbutylonitril); 1,1′-azobis(cyclohexane-1-carbonitryl); 2,2′-azobis(2-methylpropane); 2,2′-azobis(2-methylbutane) 2,2′-azobis(2-methylpentane); 2,2′-azobis(2,3-dimethylbutane); 2,2′-azobis(2-methylhexane); 2,2′-azobis(2,4-dimethylpentane); 2,2′-azobis (2,3,3-trimethylbutane); 2,2′-azobis(2,4,4-trimethylpentane); 3,3′-azobis(3-methylpentane); 3,3′-azobis(3-methylhexane); 3,3′-azobis(3,4-dimethypentane); 3,3′-azobis(3-ethylpentane); dimethyl-2,2′-azobis(2-methylpropionate); diethyl-2,2′-azobis(2-methylpropionate); di-tert-butyl-2,2′-azobis(2-methylpropionate), and the like. Note that the polymerization initiators are not limited to the above substances. More than one kind of the polymerization initiators may be combined.

In order to keep the physical properties, such as mechanical property and the thermal property, over the whole plastic optical fiber to be manufactured, it is preferable to control the polymerization degree by use of the chain transfer agent. The kind and the amount of the chain transfer agent are selected in accordance with the kinds of the polymerizable monomer. The chain transfer coefficient of the chain transfer agent to the respective monomer is described, for example, in “Polymer Handbook, 3^{rd} edition”, (edited by J. BRANDRUP & E. H. IMMERGUT, issued from JOHN WILEY&SON). In addition, the chain transfer coefficient may be calculated through the experiments in the method described in “Experiment Method of Polymers” (edited by Takayuki Ohtsu and Masayoshi Kinoshita, issued from Kagakudojin, 1972).

Preferable examples of the chain transfer agent are alkylmercaptans [for instance, n-butylmercaptan; n-pentylmercaptan; n-octylmercaptan; n-laurylmercaptan; tert-dodecylmercaptan, and the like], and thiophenols [for example, thiophenol; m-bromothiophenol; p-bromothiophenol; m-toluenethiol; p-toluenethiol, and the like]. It is especially preferable to use n-octylmercaptan, n-laurylmercaptan, and tert-dodecylmercaptan in the alkylmercaptans. Further, the hydrogen atom on C—H bond may be substituted by the fluorine atom (F) or a deuterium atom (D) in the chain transfer agent. Note that the chain transfer agents are not limited to the above substances. More than one kind of the chain transfer agents may be combined.

The plastic optical fiber may be a graded index (GI) type plastic optical fiber in which the core part has a refractive index profile in the radial direction, The GI type POF enables wide band optical transmission due to its high transmission capacity, so the GI type POF is preferably utilized for high performance communication purpose. In order to provide a refractive index profile in the POF, an additive to provide refractive index profile (hereinafter referred to as “dopant”) may be contained in the polymer matrix. Otherwise, plural polymers with different refractive indices or a copolymer of such polymers may be used as the polymer to form the core part.

The dopant is a compound that has different refractive index from the polymerizable monomer to be combined. The difference in the refractive indices between the dopant and the polymerizable monomer is preferably 0.005 or higher. The dopant has the feature to increase the refractive index of the polymer, compared to one that does not include the dopant. In comparison of the polymers produced from the monomers as described in Japanese Patent Publication No. 3332922 and Japanese Patent Laid-Open Publication No. 5-173026, the dopant has the feature that the difference in solution parameter is 7 (cal/cm³)^{1/2} or smaller, and the difference in the refractive index is 0.001 or higher. Any materials having such features may be used as the dopant if such material can stably exist with the polymers, and the material is stable under the polymerizing condition (such as temperature and pressure conditions) of the polymerizable monomers as described above.

Any materials having such features may be used as the dopant if such material can change the refractive index and stably exists with the polymers, and the material is stable under the polymerizing condition (such as temperature and pressure conditions) of the polymerizable monomers as described above. This embodiment shows the method to form refractive index profile in the core by controlling the direction of polymerization by interface gel polymerizing method, and by providing gradation in density of the refractive index control agent as the dopant during the process to form the core from the polymerizable compound mixed with the dopant. Other methods, such as diffusing the refractive index control agent after preform formation, are also possible to provide refractive index profile in the core. Hereinafter, the core having the refractive index profile will be referred to as “graded index core”. Such graded index core is used for the graded index type plastic optical member having wide range of transmission band. The dopant may be polymerizable compound, and in that case, it is preferable that the copolymer having the dopant as copolymerized component increases the refractive index in comparison of the polymer without the dopant. An example of such copolymer is MMA-BzMA copolymer.

Examples of the dopants are benzyl benzoate (BEN); diphenyl sulfide (DPS); triphenyl phosphate (TPP); benzyl n-butyl phthalate (BBP); diphenyl phthalate (DPP); diphenyl (DB); diphenylmethane (DPM); tricresyl phosphate (TCP); diphenylsoufoxide (DPSO). Among them, BEN, DPS, TPP and DPSO are preferable. In the event that the dopant is polymerizable compounds such as tribromo phenylmethacrylate, there may be advantageous in heat resistance although it would be difficult to control various properties (especially optical property) because of copolymerization of polymerizable monomer and polymerizable dopant. It is possible to control the refractive index of the POF by controlling the density and distribution of the refractive index control agent to be mixed with the core. The amount of the refractive index control agent may be appropriately chosen in accordance with the purpose of the POF, the core material, and the like.

(Other Additives)

Other additives may be contained in the core pat and the clad part so far as the transmittance properties do not decrease. For example, the additives may be used for increasing resistance of climate and durability. Further, induced emissive functional compounds may be added for amplifying the optical signal. When such compounds are added to the monomer, attenuated signal light is amplified by excitation light so that the transmission distance increases. Therefore, the optical member with such additive may be used as an optical fiber amplifier in an optical transmission link. These additives may be contained in the core part and/or the clad part by polymerizing the additives with the monomer.

The plastic optical fiber (POF) can be formed from the above described materials. It is to be noted, however, that any known method is applicable to produce the POF, and thus the present invention is not limited to the method described in the following paragraphs. For instance, the POF is directly produced by melt-extrusion and melt-spinning. As for a batch formation method to form the POF from the preform, a clad part can be layered on the core part, or a core part can be formed in a hollow pipe as the clad part.

As described in PCT Publication No. WO 93/08488 and Japanese Patent No. 3332922, the GI type plastic optical fiber preform (GI type preform) is produced by forming hollow resin pipe as the clad part, and forming the core part in the hollow pipe. It is also known that the core part of the GI type preform is produced by successively adding polymerizable compositions with different refractive indices after polymerization. The method to produce the GI type preform according to the present invention is not limited to the interface gel polymerization method. As for the resin composition, the resin composition with single refractive index may contain refractive index control agent. The resin composition may be the mixture of resins with difference refractive indices, or copolymer. The plastic optical fiber may have various refractive index profiles, such as GI type, step index type and multi step index type. The coating method according to the preferable embodiment is effective in forming the GI type and multi-step index type optical fibers that is composed of materials with different thermal properties. Also, the properties of the step index type optical fiber are affected by the heat during the coating process because of the change in the interface condition between the core part and the clad part. Thus, the coating method according to the present invention is applicable to any types of the plastic optical fiber.

The POF may be produced by heating and drawing the preform. In that case, the heating temperature to heat the preform is appropriately selected in accordance with the property of the preform such as the quality. In general, the preferable heating temperature is 180° C. to 250° C. The drawing conditions (drawing temperature, for instance) are appropriately selected in consideration of the diameter of the obtained preform, desirable diameter of POF, the material to be used, and so forth. For instance, as described in Japanese Laid-Open Patent Publication No. 07-234322, tension in drawing may be 0.1 (N) or higher for the purpose of orientating the molten plastic. In addition, as described in Japanese Laid-Open Patent Publication No. 07-234324, the tension in drawing may be 1.0 (N) or smaller for the purpose of not having strain after melt-drawing process. It is also possible to perform preliminary heating in drawing, as described in Japanese Laid-Open Patent Publication No. 08-106015. The flexural and lateral pressure properties of the POF produced by the above methods are improved by regulating the elongation at break and hardness thereof as described in Japanese Laid-Open Patent Publication No. 07-244220.

Generally, the drawn POF is not used as it is. At least one protective layer is coated with the POF to form an optical fiber wire, a plastic optical fiber cord and a plastic optical fiber cable, for the purpose of improving flexural and weather resistance, preventing decrease in property by moisture absorption, improving tensile strength, providing resistance to stamping, providing resistance to flame, protecting damage by chemical agents, noise prevention from external light, increasing the value by coloring, and the like.

[Protective Layer Material]

The material for the protective layer is selected such that the formation of the protective layer does not cause thermal damage (deformation, denaturation, thermal decompression, or the like) to the POF. Thus, the protective layer material should be hardened in reaction at a temperature between (Tg-50)° C. to the glass transition temperature Tg (° C.) of the polymer for the POF. For the purpose of reducing the manufacture cost, the formation period (the period to harden the protective layer material) is preferably between 1 second to 10 minutes, and more preferably between 1 second to 5 minutes. When the POF is composed of plural polymers, Tg is the smallest glass transition temperature among these polymers. When the polymers for POF do not have glass transition temperature, Tg is the smallest phase transition temperature (melting point, for instance).

Examples of the material for the protective layer are ordinary olefin polymers such as polyethylene (PE) and polypropylene (PP), all-purpose polymer such as vinyl chloride and Nylon. It is also possible to apply the following materials that are effective in providing mechanical property (such as bending property) due to high elasticity. Examples of such materials are rubbers as an example of the polymer, such as isoprene rubbers (for example, natural rubber and isoprene rubber), butadiene rubbers (for example, styrene-butadiene copolymer rubber and butadiene rubber), diene special rubbers (for example, nitrile rubber and chloroprene rubber), olefin rubbers (for example, ethylene-propylene rubber, acrylic rubber, butyl rubber and halide butyl rubber), ether rubbers, polysulfide rubbers and urethane rubbers.

The material for the protective layer may be a liquid rubber that exhibits fluidity in a room temperature and become solidified by application of heat. Examples of the liquid rubber are polydiene rubbers (basic structure is polyisoprene, polybutadiene, butadiene-acrylonitril copolymer, polychloroprene, and so forth), polyorefin rubbers (basic structure is polyorefin, polyisobutylene, and so forth), polyether rubbers (basic structure is poly(oxypropylene), and so forth), polysulfide rubbers (basic structure is poly(oxyalkylene disufide), and so forth) and polysiloxane rubbers (basic structure is poly(dimethyl siloxane), and so forth).

More preferably, the material for the protective layer is thermoplastic resin such as the polymer of ethylene, propylene and α-olefin. Examples of such polymer are ethylene homopolymer, ethylene-α-olefin copolymer, ethylene-propylene copolymer, and so forth. It is also possible to use a master batch in which metal hydration product and inflammable material (such as phosphorus and nitrogen) are added to these thermoplastic resins. The molecular weight (for example, number-average molecular weight and weight-average molecular weight) and the molecular weight distribution of the thermoplastic resin are not limited. But in terms of coating the plastic optical fiber with the thermoplastic resin, high fluidity of the thermoplastic resin is preferable. As for an index of the fluidity of resin, it is possible to use the melt flow rate (MFR) under the flow test (JIS K 7210 1916). The thermoplastic resin preferably has the MFR of 5 g/10 min to 150 g/10 min at the melting temperature of 190° C. It is more preferable that the MFR at the melting temperature of 190° C. is 20 g/10 min to 90 g/10 min.

As for the material of the protective layer, thermoplastic elastomer (TPE) can be used as well. The thermoplastic elastomer exhibits rubber elasticity at a room temperature, and become plasticized at a high temperature for easy molding. Examples of the thermoplastic elastomer are styrene thermoplastic elastomers, olefin thermoplastic elastomers, vinyl chloride thermoplastic elastomers, urethane thermoplastic elastomers, ester thermoplastic elastomers, amide thermoplastic elastomers, and so forth. Other materials than those described above can be used as long as the coating layer is formed at a temperature of equal to or less than the glass transition temperature Tg (° C.) of the POF polymer. For example, it is possible to use copolymer and mixed polymer of the above described materials or other materials.

The material obtained by thermal hardening the mixed liquid of a polymer precursors and reaction agent is preferably used as the protective layer material. An example of the material is one-pack type thermosetting urethane composition produced from NCO block prepolymer and powder-coated amine, as described in Japanese Patent Laid-Open Publication No. 10-158353. Another example is one-pack type thermosetting urethane composition that is composed of urethane pre-polymer with NCO group, described in WO 95/26374, and solid amine having the size of 20 μm or smaller. For the purpose of improving the properties of the primary protective layer, additives and fillers may be added to the primary protective layer. Examples of the additives are incombustibility, antioxidant, radical trapping agent, lubricant. The fillers may be made from organic and/or inorganic compound.

[Method for Forming Protective Layer]

The method to form the protective layer is explained with reference to the drawings. The coating apparatus may be connected wit the drawing apparatus for performing the coating process simultaneously or just after the drawing process.

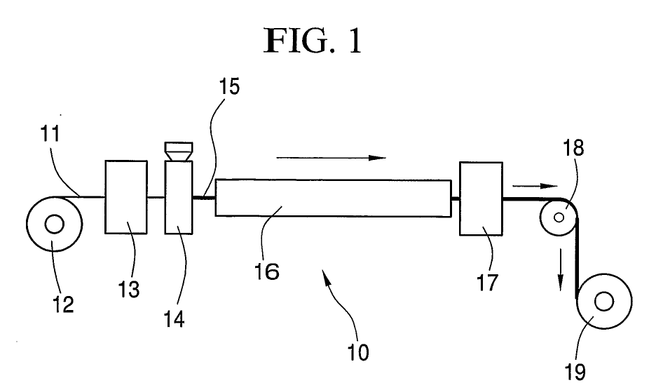

A coating line 10 for forming the protective layer around the plastic optical fiber (POF) 11 is illustrated. A well-known coating line for coating an electric cable and a glass optical fiber may be used as the coating line 10 according to this embodiment. The POF 11 is fed from a feeding machine 12 to the cooler machine 13 for cooling the POF 11 to the temperature of 5° C. to 35° C. Cooling the POF 11 before forming the protective layer is preferable in reducing thermal damage in the coating process, but the coating line 10 may not have the cooler machine 13. Thereafter, a coating device 14 coats thermoplastic resin (coating material) around the POF 11 to manufacture a plastic optical fiber strand (optical fiber strand) 15. The coating process will be explained later. The optical fiber stand 15 is fed to a water tank 16 for cooling with cold water, and then fed to a dehydrate machine 17 to remove water on the surface of the optical fiber strand 15. The optical fiber strand 15 may be cooled by use of a machine other than the dehydrate machine 17. The optical fiber strand 15 is fed to a winding machine 19 via a feeding roller 18. Although the coating line 10 in FIG. 1 supplies the POF 11 from the feeding machine 12, the coating line 10 is not limited to the one illustrated in FIG. 1. For example, a drawing apparatus (not illustrated) for forming the POF may be integrated with the coating line. In that case, the preform is continuously supplied from the drawing apparatus, and then the POF is coated with the coating layer.

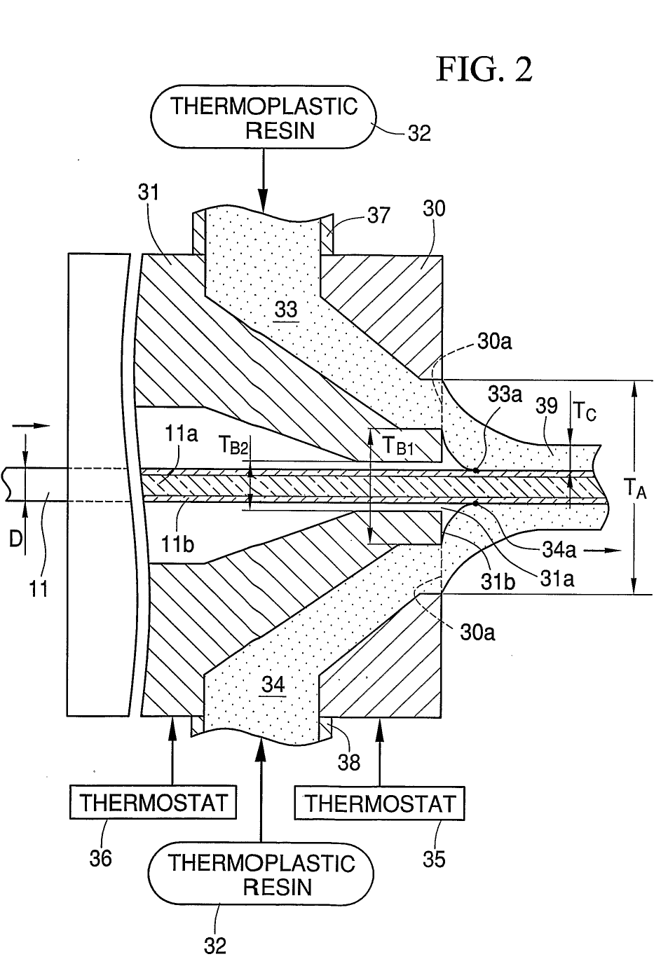

In FIG. 2, a die 30 and a nipple 31 provided in the coating device 14 is illustrated. In the coating device 14, the nipple 31 is fitted into the die 30 such that the gap between the die 30 and the nipple 31 form a resin passage 33, 34 for passing the thermoplastic resin 32 as the coating material. For the purpose of keeping the fluidity of the thermoplastic resin 32, there are thermostats 35, 36 each of which is provided with the die 30 and the nipple 31. The temperature (coating temperature) of the thermoplastic resin 32 in the coating process is preferably as low as possible for the purpose of reducing the amount of heat transferred to the POF. When the coating material is polyethylene for example, the coating temperature is preferably 140° C. or lower, and more preferably 130° C. or lower. The lower limit of the coating temperature is not limited, but the lower limit of the coating temperature must be the temperature that the thermoplastic resin 32 has fluidity. When the thermoplastic resin 32 is low density polyethylene for example, the lower limit of the coating temperature is preferably 100° C. to 110° C. The POF 11 is passed through the fiber passage formed in the nipple 31, and fed outside the nipple 31 via a fiber outlet opening 31a.

The POF 11 is composed of a core part 11a as the optical channel and a clad part 11b formed around the core part 11a. The shape of the POF 11 is not limited, but the diameter D (μm) is preferably 200 μm to 1500 μm, and more preferably 200 μm to 800 μm. Although the feeding speed of the POF 11 is not limited, the feeding speed is preferably 10 m/min to 100 m/min. The feeding speed of lower than 10 m/min causes to get the productivity worse, and thus to increase the manufacture cost. Moreover, since the period to pass the fiber passage in the heated nipple 31 becomes long, the POF 11 may be thermally damaged by the heat emitted from the nipple 31. On the other hand, the feeding speed of faster than 100 m/min causes to lose adhesiveness to the thermoplastic resin 32 as the coating material, and thus causes problems such as separation of the thermoplastic resin 32 and variation of the mechanical property because of crystallization of the resin.

The gap between the die 30 and the nipple 31 constitutes the resin passage 33, 34. The thermoplastic resin 32 with fluidity is heated at a predetermined temperature, and flown to the resin passage 33, 34 from the resin inlet 37, 38. The molten thermoplastic resin 32 through the resin passage 33, 34 is flown out toward the POF 11 via a resin outlet 30a formed between the die edge and the nipple edge. The thermoplastic resin 32 is coated on the outer surface of the POF 11 as the protective layer 39. The optical fiber strand 15 having the protective layer 39 around the POF 11 is then subject to the cooling process in the water tank 16 (see FIG. 1).

In order to provide a sufficient clearance in the resin outlet 30a and coat the POF 11 with the thermoplastic resin 32 easily, the clearance (T_{A}−T_{B1}) satisfies the following formula (1):
20 (μm)≦(T_{A}−T_{B1})≦1500 (μm) (1)

wherein T_{A} (μm) denotes the diameter of the opening of the die 30, and T_{B1} (μm) denotes the outer diameter of the nipple 31. When the clearance is smaller than 20 μm, the pressure of thermoplastic resin 32 in the resin passage 33, 34 becomes high, so extreme stress will be applied to the POF 11 when the thermoplastic resin 32 contacts the POF 11. Thereby, there is possibility that the refractive index of the POF 11 is varied and the optical property (such as the transmission loss) of the POF becomes worse. On the other hand, when the clearance is larger than 1500 μm, the coating layer 39 becomes too thick, and the appearance of the coating layer 39 becomes worse due to dripping of the molten thermoplastic resin. Moreover, a thick protective layer 39 makes it difficult to cool the thermoplastic resin 32 uniformly, so the POF 11 may be thermally damaged and the optical fiber strand 15 may have a swelling.

Next, the difference (T_{B2}−D) between the inner diameter T_{B2} (μm) of the nipple 31 to pass the POF 11 and the diameter D (μm) of the POF 11 satisfies the following formula (2):
20 (μm)≦(T_{B2}−D)≦600 (μm) (2)

If the difference (T_{B2}−D) is less than 20 μm, the POF 11 will be thermally damaged by the heated nipple 31, and the POF 11 will be contacted to the nipple 31 to cause physical damage of the POF 11. On the other hand, if the difference (T_{B2}−D) is more than 600 μm, adhesiveness of the POF 11 to the thermoplastic resin 32 becomes worse.

The difference (T_{B1}−T_{B2}) between the outer diameter T_{B1} (μm) and the inner diameter T_{B2} (μm) of the nipple 31 satisfies the following formula (3):
400 (μm)<(T_{B1}−T_{B2})≦1500 (μm) (3)

If the difference (T_{B1}−T_{B2}) is more than 1500 μm, the positions 33a, 34a to contact the thermoplastic resin 32 to the POF 11 becomes far from the nipple end 31b, so the positions 33a, 34a tend to be fluctuated. As a result, the optical fiber strand 15 will have swelling. The lower limit of the difference (T_{B1}−T_{B2}) is not limited, but larger than 400 μm is preferable in term of manufacture cost, strength and durability of the nipple 31.

By use of the mold comprised of the die 30 and the nipple 31, it is possible to coat the POF 11 with the thermoplastic resin 32 without causing problems such as the thermal damage to the POF 11 and improper coating. The diameter D of the POF 11 is preferably 200 μm to 1500 μm, and more preferably 200 μm to 800 μm. In that case, the coating layer 39 having the thickness Tc (μm) of 100 μm to 500 μm makes it possible to prevent excessive stress to the POF 11. It is to be noted that some of the coating material cause shrinkage when the protective layer 39 is solidified.

The POF may have a second (or more) protective layer around the above described protective layer as the first protective layer. If the first protective layer has a thickness enough to decrease the thermal damage to the POF, the requirement of the hardening temperature of the second protective layer becomes less strict compared with the first protective layer. The second protective layer may be provided with the additives such as incombustibility, antioxidant, radical trapping agent and lubricant. The flame retardants are resin with halogen like bromine, an additive and a material with phosphorus. Metal hydroxide is preferably used as the flame retardant for the purpose of reducing toxic gas emission.

The POF may be coated with plural coat layers with multiple functions. Examples of such coat layers are a flame retardant layer described above, a barrier layer to prevent moisture absorption, moisture absorbent (moisture absorption tape or gel, for instance) between the protective layers or in the protective layer, a flexible material layer and a styrene forming layer as shock absorbers to relax stress in bending the POF, a reinforced layer to increase rigidity. The thermoplastic resin as the coat layer may contain structural materials to increase the strength of the optical fiber cable. The structural materials are a tensile strength fiber with high elasticity and/or a metal wire with high rigidity. Examples of the tensile strength fibers are an aramid fiber, a polyester fiber, a polyamid fiber. Examples of the metal wires are stainless wire, a zinc alloy wire, a copper wire. The structural materials are not limited to those listed above. It is also possible to provide other materials such as a metal pipe for protection, a support wire to hold the optical fiber cable. A mechanism to increase working efficiency in wiring the optical fiber cable is also applicable.

In accordance with the way of use, the POF is selectively used as a cable assembly in which the POFs are circularly arranged, a tape core wire in which the POFs are linearly aligned, a cable assembly in which the tape core wires are bundled by using a band or LAP sheath, or the like.

It is preferable to ensure to fix the end of the POF as the optical member according to the present invention by using an optical connector. The optical connectors widely available on the market are PN type, SMA type, SMI type, FO5 type, MU type, FC type, SC type, and the like.

A system to transmit optical signals through the POF, the optical fiber wire and the optical fiber cable as the optical member comprises optical signal processing devices including optical components, such as a light emitting element, a light receiving element, an optical switch, an optical isolator, an optical integrated circuit, an optical transmitter and receiver module, and the like. Such system may be combined with other POFs. Any know techniques can be applied to the present invention. The techniques are described in, for example, “‘Basic and Practice of Plastic Optical Fiber’ (issued from NTS Inc.)”, “‘Optical members can be Loaded on Printed Wiring Assembly, at Last’ in Nikkei Electronics, vol. Dec. 3, 2001”, pp. 110-127”, and so on. By combining the optical member according to with the techniques in these publications, the optical member is applicable to short-distance optical transmission system that is suitable for high-speed and large capacity data communication and for control under no influence of electromagnetic wave. Concretely, the optical member is applicable to wiring in apparatuses (such as computers and several digital apparatuses), wiring in trains and vessels, optical linking between an optical terminal and a digital device and between digital devices, indoor optical LAN in houses, collective housings, factories, offices, hospitals, schools, and outdoor optical LAN.

Further, other techniques to be combined with the optical transmission system are disclosed, for example, in “‘High-Uniformity Star Coupler Using Diffused Light Transmission’ in IEICE TRANS. ELECTRON., VOL. E84-C, No. 3, MARCH 2001, pp. 339-344”, “‘Interconnection in Technique of Optical Sheet Bath’ in Journal of Japan Institute of Electronics Packaging., Vol. 3, No. 6, 2000, pp. 476-480”. Moreover, there are am optical bus (disclosed in Japanese Patent Laid-Open Publications No. 10-123350, No. 2002-90571, No. 2001-290055 and the like); an optical branching/coupling device (disclosed in Japanese Patent Laid-Open Publications No. 2001-74971, No. 2000-329962, No. 2001-74966, No. 2001-74968, No. 2001-318263, No. 2001-311840 and the like); an optical star coupler (disclosed in Japanese Patent Laid-Open Publications No. 2000-241655); an optical signal transmission device and an optical data bus system (disclosed in Japanese Patent Laid-Open Publications No. 2002-62457, No. 2002-101044, No. 2001-305395 and the like); a processing device of optical signal (disclosed in Japanese Patent Laid-Open Publications No. 2000-23011 and the like); a cross connect system for optical signals (disclosed in Japanese Patent Laid-Open Publications No. 2001-86537 and the like); a light transmitting system (disclosed in Japanese Patent Laid-Open Publications No. 2002-26815 and the like); multi-function system (disclosed in Japanese Patent Laid-Open Publications No. 2001-339554, No. 2001-339555 and the like); and various kinds of optical waveguides, optical branching, optical couplers, optical multiplexers, optical demultiplexers and the like. When the optical system having the optical member according to the present invention is combined with these techniques, it is possible to construct an advanced optical transmission system to send/receive multiplexed optical signals. The optical member according to the present invention is also applicable to other purposes, such as for lighting, energy transmission, illumination, and sensors.

[Experiments]

The present invention will be described in detail with reference to Experiments (1)-(2) as the embodiments of the present invention and Experiments (3)-(5) as the comparisons. The materials, contents, operations and the like will be changed so far as the changes are within the spirit of the present invention. Thus, the scope of the present invention is not limited to the Experiments described below. The description below explains Experiment (1) in detail. Regarding Experiments (2)-(5), the portions different from Experiment (1) will be explained. The conditions and the results of the experiments are listed in Table 1 below. In Table 1, the leftmost column shows the number of the Experiment.

In Experiment (1), predetermined amount of solution of monomer (methacryl acid-methyl (in which water is decreased to 1000 ppm or less)) is poured into a cylindrical and rigid polymerizing chamber having the inner diameter of 22 mm and the length of 600 mm. The inner diameter of the polymerizing pot corresponds to the outer diameter of the preform to be produced. As the polymerization initiator, dimethyl-2,2′-azobis(2-methylpropyonate) of 0.5 wt % of the monomer solution is contained. In addition, as the chain transfer agent, n-laurylmercaptan of 0.62 wt % of the monomer solution is contained. While the polymerization chamber is concussed in 60° C. water bath, the monomer solution is subject to preliminary polymerization for 2 hours. Thereafter, the polymerizing chamber is kept horizontally (the axial direction of the cylindrical chamber is kept horizontally) at 65° C., and then thermal polymerization process is carried out for three hours while rotating the cylindrical chamber at a speed of 3000 rpm. Thereafter, the thermal polymerization process at 90° C. is performed for 24 hours, so that a cylindrical pipe formed from high polymer (PMMA) is obtained.

Next, the solution of the monomer (methacryl acid-methyl (in which water is decreased to 1000 ppm or less)) as the core material is mixed with dibutyl phthalate as the refractive index control component. The amount of the dibutyl phthalate is 10 wt % of the monomer solution. After the monomer mixture solution is filtered through membrane filter made from polytetrafluoroethylene with the accuracy of 0.2 μm, the filtered solution is directly poured into the hollow portion of the cylindrical pipe. As the polymerization initiator, di-t-butylperoxide of 0.016 wt % of the monomer mixture solution is added. As the chain transfer agent, n-laurylmercaptan of 0.27 wt % of the monomer mixture solution is added. The cylindrical tube containing this monomer mixture solution is inserted in a glass pipe having the diameter larger by 9% than that of the cylindrical pipe, and then the glass pipe is kept vertically and stationary in a pressure polymerization chamber. Then, in nitrogen atmosphere, the pressure polymerization chamber is pressurized into 0.1 MPa (gauge pressure), and the monomer mixture solution is subject to thermal polymerization at 90° C. for 48 hours. Thereafter, the pressure in the pressure polymerization chamber increases to 0.4 MPa (gauge pressure), and then the monomer mixture solution is subject to thermal polymerization at 120° C. for 24 hours. After thermal polymerization, heat treatment is performed to obtain the preform. The weight average molecular weight of the preform is 106,000, and the molecular weight distribution ((weight average molecular weight)/(number average molecular weight)) is 2.1. The glass transition temperature of the preform takes the lowest value of 90° C. (=Tg) in the center of the core part. The glass transition temperature in the core part gradually increases accordance with the refractive index profile. The glass transition temperature in the outermost region of the core part is 110° C.

The preform does not have any bubbles that would be generated due to volume shrinkage at the time when polymerization is completed. The preform is heated at 230° C. and drawn to obtain the POF having the diameter of 316 μm. The measured transmission loss of the POF at the wavelength of 650 nm is 160 dB/km, and the measured transmission loss of the POF at the wavelength of 850 nm is 1250 dB/km.

The protective layer is formed around the POF by use of an extruder (diameter φ of the screw: 40 mm) to which a mold having the die 30 and the nipple 31 is attached. The diameter T_{A} (μm) of the die 30 is 2100 μm. The outer diameter T_{B1} (μm) and the inner diameter T_{B2} (μm) of the nipple 31 are 1100 μm and 500 μm, respectively. Low density polyethylene (LDPE; JMA07A manufactured by JPO; MFR=50 g/10 min) as the coating material is extruded from the extruder under the condition of 125° C. and 360 g/min. While the plastic optical fiber (thickness D of 316 μm) is fed at the speed of 20 m/min, the coating material is contacted to the plastic optical fiber and extended to have a predetermined thickness. The optical fiber strand 15 with the coating material is subject to cooling process, and then wound around a reel. The thickness T_{c} of the protective layer is 220 μm, and the diameter (cord diameter) of the optical fiber strand is 750 μm. It is to be noted that the thickness T_{c} of the protective layer is the value measured after the resin is dried. The transmission loss of the coated plastic optical fiber is measured, and the increase in the transmission loss after forming the protective layer is 2 dB/km.

In Experiment (2), the same extruder as Experiment (1) is used. Linear low density polyethylene (LLDPE; Nipolon-L manufactured by Tosoh Corp.; MFR=20 g/10 min) as the coating material is extruded from the extruder under the condition of 130° C. and 390 g/min. While the plastic optical fiber (thickness D of 316 μm) is fed at the speed of 20 m/min, the coating material is contacted to the plastic optical fiber and extended to have a predetermined thickness. The optical fiber strand 15 with the coating material is subject to cooling process, and then wound around a reel. The thickness T_{c} of the protective layer is 245 μm, and the diameter (cord diameter) of the optical fiber strand is 805 μm. The transmission loss of the coated plastic optical fiber is measured, and the increase in the transmission loss after forming the protective layer is 7 dB/km.

In Experiment (3) as the comparison experiment, the same extruder as Experiment (1) is used. The diameter T_{A} (μm) of the die 30 is 3100 μm. The outer diameter T_{B1} (μm) and the inner diameter T_{B2} (μm) of the nipple 31 are 1100 μm and 500 μm, respectively. Low density polyethylene (LDPE; JMA07A manufactured by JPO; MFR=50 g/10 min) as the coating material is extruded from the extruder under the condition of 125° C., and the plastic optical fiber (thickness D of 316 μm) is coated with the protective layer. The thickness T_{c} of the protective layer is 240 μm, and the diameter (cord diameter) of the optical fiber strand is 800 μm. The transmission loss of the coated plastic optical fiber is measured, and the increase in the transmission loss after forming the protective layer is 75 dB/km.

In Experiment (4) as the comparison experiment, the same extruder as Experiment (1) is used. The diameter T_{A} (μm) of the die 30 is 2100 μm. The outer diameter T_{B1} (μm) and the inner diameter T_{B2} (μm) of the nipple 31 are 1700 μm and 1000 μm, respectively. Low density polyethylene (LDPE; JMA07A manufactured by JPO; MFR=50 g/10 min) as the coating material is extruded from the extruder under the condition of 125° C., and the plastic optical fiber (thickness D of 316 μm) is coated with the protective layer. The thickness T_{c} of the protective layer is 245 μm, and the diameter (cord diameter) of the optical fiber strand is 805 μm. The transmission loss of the coated plastic optical fiber is measured, and the increase in the transmission loss after forming the protective layer is 65 dB/km.

In Experiment (5) as the comparison experiment, the same extruder as Experiment (1) is used. The diameter T_{A} (μm) of the die 30 is 2500 μm. The outer diameter T_{B1} (μm) and the inner diameter T_{B2} (μm) of the nipple 31 are 2100 μm and 500 μm, respectively. Low density polyethylene (LDPE; JMA07A manufactured by JPO; MFR=50 g/10 min) as the coating material is extruded from the extruder under the condition of 125° C., and the plastic optical fiber (thickness D of 316 μm) is coated with the protective layer. The thickness T_{c} of the protective layer is 243 μm, and the diameter (cord diameter) of the optical fiber strand is 800 μm. The transmission loss of the coated plastic optical fiber is measured, and the increase in the transmission loss after forming the protective layer is 50 dB/km.

TABLE 1

| | Protective | | | | | Increase in |
|---|---|---|---|---|---|---|
| | Layer | Formula | | | Thickness | Transmission |
| Experiment | Material | (1) | (2) | (3) | Tc (μm) | Loss (dB/km) |
| (1) | LDPE | ∘ | ∘ | ∘ | 220 | 2 |
| (2) | LLDPE | ∘ | ∘ | ∘ | 245 | 7 |
| (3) | LDPE | x | ∘ | ∘ | 240 | 75 |
| (4) | LDPE | ∘ | x | ∘ | 245 | 65 |
| (5) | LDPE | ∘ | ∘ | x | 243 | 50 |

It is to be noted that, in Table 1, the Formulae (1)-(3) are as follows:
20 (μm)≦(T_{A}−T_{B1})≦1500 (μm) (1)
20 (μm)≦(T_{B2}−D)≦600 (μm) (2)
400 (μm)<(T_{B1}−T_{B2})≦1500 (μm) (3)

wherein T_{A} (μm) denotes the diameter of the die, T_{B1} (μm) denotes the outer diameter of the nipple, T_{B2} (μm) denotes the inner diameter of the nipple, and D (μm) denotes the diameter of the optical plastic fiber. In addition, the mark “∘” indicates that the experimental condition satisfies the formula, and the mark “x” indicates that the experimental condition does not satisfy the formula.

The above Table 1 shows that the increase in the transmission loss becomes smaller than 10 dB/km after the coating process of either LDPE or LLDPE when mold with the die and the nipple satisfying the formulae (1)-(3).

### INDUSTRIAL APPLICABILITY

The present invention relates to a method and an apparatus utilized in coating a surface of a plastic optical fiber.

1. A coating method for coating a plastic optical fiber with a thermoplastic resin by use of a nipple and a die, the nipple being fitted into an opening formed in the die, the plastic optical fiber being coated with the thermoplastic resin by flowing the thermoplastic resin through a resin passage formed between the die and the nipple and by coating the thermoplastic resin through the resin passage around the plastic optical fiber that passes an optical fiber passage formed in the nipple;
wherein the die and the nipple satisfy the conditions of:
20 (μm)≦(T_{A}−T_{B1})≦1500 (μm)
20 (μm)≦(T_{B2}−D)≦600 (μm)
400 (μm)<(T_{B1}−T_{B2})≦1500 (μm)
wherein T_{A} (μm) denotes the diameter of the die, T_{B1} (μm) denotes the outer diameter of the nipple, T_{B2} (μm) denotes the inner diameter of the nipple, and D (μm) denotes the diameter of the optical plastic fiber.

2. The coating method according to claim 1, wherein the diameter of the plastic optical fiber is 200 μm to 1500 μm, and the thickness of the thermoplastic resin coated around the plastic optical fiber is 100 μm to 500 μm.

3. The coating method according to claim 1, wherein the melt flow rate of the thermoplastic resin at the melting temperature of 190° C. is 5 g/10 min to 150 g/10 min.

4. A coating device for coating a plastic optical fiber with a thermoplastic resin, the coating device comprising:
a nipple in which an optical fiber passage is formed; and
a die in which an opening is formed for fitting the nipple, the plastic optical fiber being coated with the thermoplastic resin by flowing the thermoplastic resin through a resin passage formed between the die and the nipple and by coating the thermoplastic resin through the resin passage around the plastic optical fiber that passes the optical fiber passage of the nipple;
wherein the die and the nipple satisfy the conditions of:
20 (μm)≦(T_{A}−T_{B1})≦1500 (μm)
20 (μm)≦(T_{B2}−D)≦600 (μm)
400 (μm)<(T_{B1}−T_{B2})≦1500 (μm)
wherein T_{A} (μm) denotes the diameter of the die, T_{B1} (μm) denotes the outer diameter of the nipple, T_{B2} (μm) denotes the inner diameter of the nipple, and D (μm) denotes the diameter of the optical plastic fiber.
